(19) United States
(12) Patent Application Publication
(10) Pub. No.: US 2002/0026344 A1
(43) Pub. Date: Feb. 28, 2002

(54) AUTOMATIC SELECTIVE PAGING SYSTEM AND METHOD

(76) Inventor: RHODA YAKER, ANNANDALE, NJ (US)

Correspondence Address: THOMAS STAFFORD, 4173 ROTHERHAM COURT, PALM HARBOR, FL, 34685

(21) Appl. No.: 09/115,343

(22) Filed: Jul. 14, 1998

(51) Int. Cl. G06F 17/60

(52) U.S. Cl. 705/9

(57) ABSTRACT

An automatic selective paging system and method is utilized in which at least one entity of a predetermined group of entities is automatically selected as being available to answer a page in accordance with prescribed criteria, and then is paged. Specifically, a page request or requests is received from, for example, a salesperson, customer representative, account representative, customer, anyone needing information, assistance, advice, help of any sort or the like. To realize this, individual entities in the group of entities populate at least one associated scheduler with their individual schedules indicating availability to provide a service, for example, times of a day, days of a week, etc. These individual schedules are available to a paging system and, for example, to a hunt group therein. When a page is initiated for an entity to provide a service, a hunt group identifies an individual entity within the hunt group, for example, CEO, company president, other executive, technical manager, engineer, product manager, marketer, salesperson, technician, support staff, project team, customer service organization or the like, that is currently available to receive the page, as determined from the available schedules. Once the individual entity is identified, it is paged and provided information so that it may appropriately respond to the page. More specifically, each of a plurality of entities, assigned to one or more hunt groups, populates an individual scheduler associated with it, with its schedule that indicates availability or not to answer pages. Availability to answer a page may be determined from the fact that the entity has no other commitment scheduled for the particular time interval. In a specific embodiment of the invention, the individual entity that receives the page may at its discretion either accept the page or deny it. If the page is accepted, the individual entity answers it and nothing further need be done. However, if the page is denied, then this is acknowledged back to the paging system and the particular hunt group identifies the next available entity to be paged. This process is iterated until the page is accepted by a paged entity. In another embodiment, when an entity denies acceptance of a page, the entity's schedule may be updated to change it to reflect the paged entity's availability to answer pages. In still another embodiment, a plurality of hunt groups are available in which the individual hunt groups include a plurality of entities related by a specific type of task to be addressed by an associated page number. In a further embodiment, a plurality of hunt groups are available in which the individual hunt groups are populated by specific entities dependent on an assigned priority level. The individual entity initiating a page is identified and its priority level determined and, then, a hunt group corresponding to the priority level is assigned to the initiated page call. A specific task can also be delineated into a plurality of hunt groups in which the individual hunt groups are each associated with a specific priority level.

### TECHNICAL FIELD

This invention relates to paging systems and, more particularly, to paging at least one of a predetermined number of telephone numbers.

### BACKGROUND OF THE INVENTION

Paging systems are now well known in the art and it has become commonplace to call a telephone number, which accesses a paging system that pages a specific individual. Other paging arrangements are known that page an individual in order to remind or alert him/her of events on his/her schedule. Still other paging arrangements are known that provide for the paged individual to acknowledge having received the page. All of these prior known paging arrangements, however, are directed toward paging a specific individual associated with the page number being called.

### SUMMARY OF THE INVENTION

Problems and limitations of prior known paging arrangements are overcome by employing an automatic selective paging system and method in which at least one entity of a predetermined group of entities is automatically selected as being available to answer a page in accordance with prescribed criteria, and, then, the selected entity is paged.

Specifically, a page request or requests is received from, for example, a salesperson, customer representative, account representative, customer, anyone needing information, assistance, advice, help of any sort or the like. To realize this, individual entities in the group of entities populate at least one associated scheduler with their individual schedules indicating availability to provide a service, for example, times of a day, days of a week, etc. These individual schedules are available to a paging system and, for example, to a hunt group therein. When a page is initiated for an entity to provide a service, a hunt group identifies an individual entity within the hunt group, for example, CEO, company president, other executive, technical manager, engineer, product manager, marketer, salesperson, technician, support staff, project team, customer service organization or the like, that is currently available to receive the page, as determined from the available schedules. Once the individual entity is identified, it is paged and provided information so that it may appropriately respond to the page.

More specifically, each of a plurality of entities, assigned to one or more hunt groups, populates an individual scheduler associated with it, with its schedule that indicates availability or not to answer pages. Availability to answer a page may be determined from the fact that the entity has no other commitment scheduled for the particular time interval.

In a specific embodiment of the invention, the individual entity that receives the page may at its discretion either accept the page or deny it. If the page is accepted, the individual entity answers it and nothing further need be done. However, if the page is denied, then this is acknowledged back to the paging system and the particular hunt group identifies the next available entity to be paged. This process is iterated until the page is accepted by a paged entity.

In another embodiment, when an entity denies acceptance of a page, the entity's schedule may be updated to change it to reflect the paged entity's availability to answer pages.

In still another embodiment, a plurality of hunt groups are available in which the individual hunt groups include a plurality of entities related by a specific type of task to be addressed by an associated page number.

In a further embodiment, a plurality of hunt groups are available in which the individual hunt groups are populated by specific entities dependent on an assigned priority level. The individual entity initiating a page is identified and its priority level determined and, then, a hunt group corresponding to the priority level is assigned to the initiated page call.

A specific task can also be delineated into a plurality of hunt groups in which the individual hunt groups are each associated with a specific priority level.

### BRIEF DESCRIPTION OF THE DRAWING

FIG. 1 shows, in simplified block diagram form, details of a paging system including an embodiment of the invention;

FIG. 2 shows, in simplified block diagram form, details of a paging system including another embodiment of the invention;

FIG. 3 shows, in simplified block diagram form, details of a paging system including still another embodiment of the invention;

FIG. 4 shows, in simplified block diagram form, details of a paging system including a further embodiment of the invention;

FIG. 5 is a flow chart illustrating steps in one paging process that may be employed in the embodiments of FIGS. 1 and 3;

FIG. 6 is a flow chart illustrating steps in another paging process that may be employed in the embodiments of FIGS. 1 and 3;

FIG. 7 is a flow chart illustrating steps in a paging process that may be employed in the embodiments of FIGS. 2 and 4;

FIG. 8 is a flow chart illustrating steps in a paging process that may be employed in the embodiments of FIGS. 2 and 4;

FIG. 9 is a flow chart illustrating steps in another paging process that may be employed in the embodiments of FIGS. 2 and 4; and

FIG. 10 is a flow chart illustrating steps in still another paging process that may be employed in the embodiments of FIGS. 2 and 4.

### DETAILED DESCRIPTION

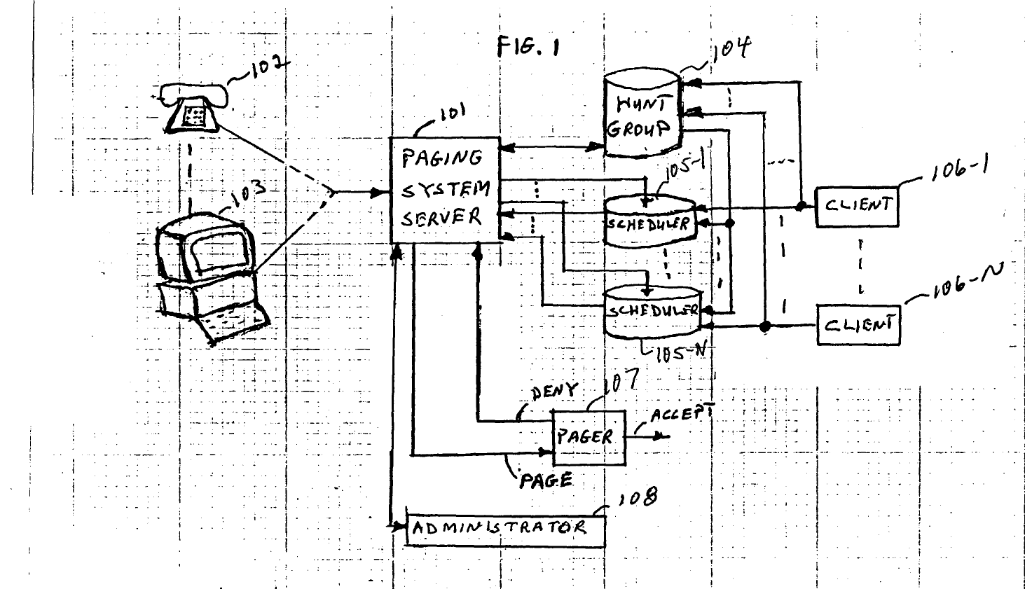

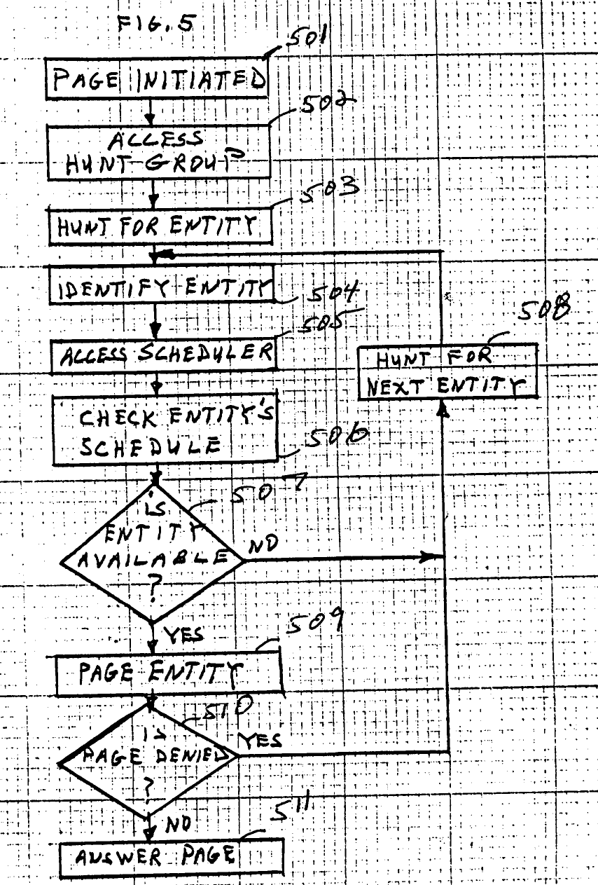

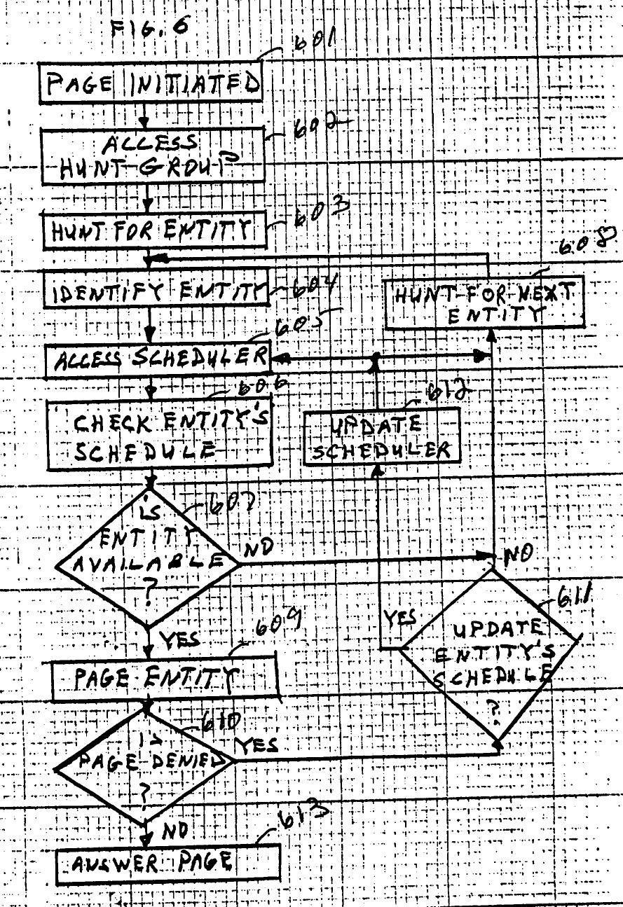

FIG. 1 shows, in simplified block diagram form, details of a paging system including an embodiment of the invention. Specifically, shown is paging system server 101, which receives page requests via page initiation calls or the like. Paging system server 101 is responsive to a page request to initiate selecting an entity to answer the page request by coordinating the selection of an available entity and, then, paging the selected entity to provide it with information to answer the page. Pages may be initiated from any of a number of devices, for example, a telephone station set 102, personal computer 103, wireless telephone, special paging device, or the like. Paging system server 101 is shown here as stand-alone equipment, which is of a type well known in the art. However, it will be apparent to those skilled in the art that such a paging system server may be incorporated in, for example, a digital switching system like a 5ESS® switch, a DEFINITY® switch, PARTNER® key telephone system, (all of which are commercially available from Lucent Technologies Inc), or the like. As shown, associated with paging system server 101 are hunt group unit 104, a plurality of scheduler units 105-1 through 105-N, a plurality of client units 106-1 through 106-N and pager unit 107. Again, the hunt group unit 104 and scheduler units 106 may be incorporated in paging system server 101 or in, for example, a digital switching system like a 5ESS® switch, a DEFINITY® switch, PARTNER® key telephone system, or the like, noted above. It is noted that hunt group techniques are also well known in the art. In this example, a hunt group may be comprised of any number of individuals, executives, technical advisors, service organizations, product organizations, technical staff, installation staff or any desired group that is identified to address a task, answer questions or provide any service associated with a page site to be called. Indeed, an entity identified in a hunt group can be an individual, a company, a pointer to another entity or a pointer to a hierarchy of other hunt groups. Thus, the entities (i.e., their individual identifications) in a hunt group are stored in hunt group unit 104. The schedules of individuals or entities in the hunt group, indicating their availability to answer a page or not may be inputted into a single scheduler associated with paging system server 101 or, as shown in this example, on an individual scheduler 105-1 through 105-N, each of which is associated with a specific entity. Such schedulers are well known in the art, one example being Microsoft Schedule+, which is commercially available from Microsoft Corporation. The schedules may be administered by a system administrator 108 or individually. Indeed, they may even be updated during a page request by an entity, although indicated as being available to answer a page, for some reason is no longer available because of unforeseen schedule changes or last minute commitments. Client units 106 may be anyone of a number of known devices capable of interfacing with a scheduler. For example, a personal computer, a laptop computer, palm pilot unit, or any other personal computing device. Additionally, the individuals or entities identified as populating the hunt group(s) may be updated from time-to-time as needed. In this example, such hunt group updating is done by administrator 108 through coordination with the individuals or entities in the group. Additionally, the individuals or entities in a hunt group(s) can update by themselves which hunt group or groups that they are presently to be in. Further, the hunt procedure employed in hunt group unit 104 may be random, sequential, hierarchical or any desired procedure. Pager unit 107 is also a well known pager device, for example, a beeper, a pager, a cellular telephone, computer or anything that can receive a paging signal for indicating that an entity is being paged. In this example, pager unit 107 preferably is a two way device that allows an entity being paged to deny the page and, if desired to update its schedule. Updating the entities schedule is readily achieved, for example, by a computer accessing the scheduler, or by a paging device having an alpha-numeric keyboard which can send alpha-numeric messages to the scheduler to block intervals of time. Of course if the page is accepted, nothing further is required by the entity that was paged, but to answer the page. Operation of the system shown in FIG. 1 for automatically, selectively paging an entity is described below in conjunction with FIGS. 5 and 6.

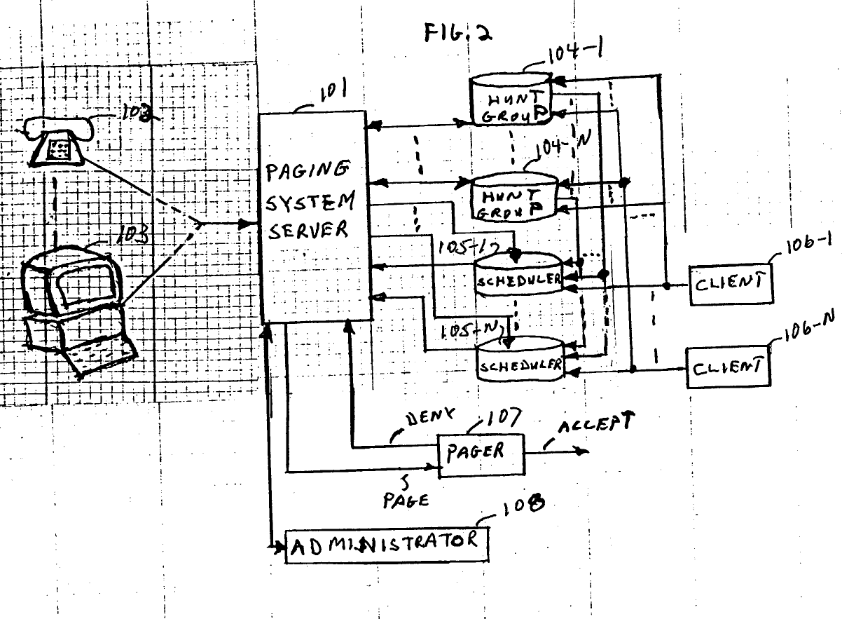

FIG. 2 shows, in simplified block diagram form, details of a paging system including another embodiment of the invention. Elements of the system shown in FIG. 2 that are the same as those shown in FIG. 1 have been similarly numbered and those that have essentially similar functionality will not be discussed again in detail. As shown, the paging system of FIG. 2 includes paging system server 101, access units 102 and 103 among others, a plurality of hunt group units 104-1 through 104-N, a plurality of schedulers 105-1 through 105-N, a plurality of client units 106-1 through 106-N, pager unit 107 and administrator unit 108. Each of the plurality of hunt groups 104-1 through 104-N may be populated with entities, for example, in relationship to a priority assigned to a source initiating the page or just to a specific source. Then, in this example, each of the hunt groups 104 has access to each of schedulers 105-1 through 105-N in order to hunt for an available entity in the group assigned to the source priority or to the just the source.

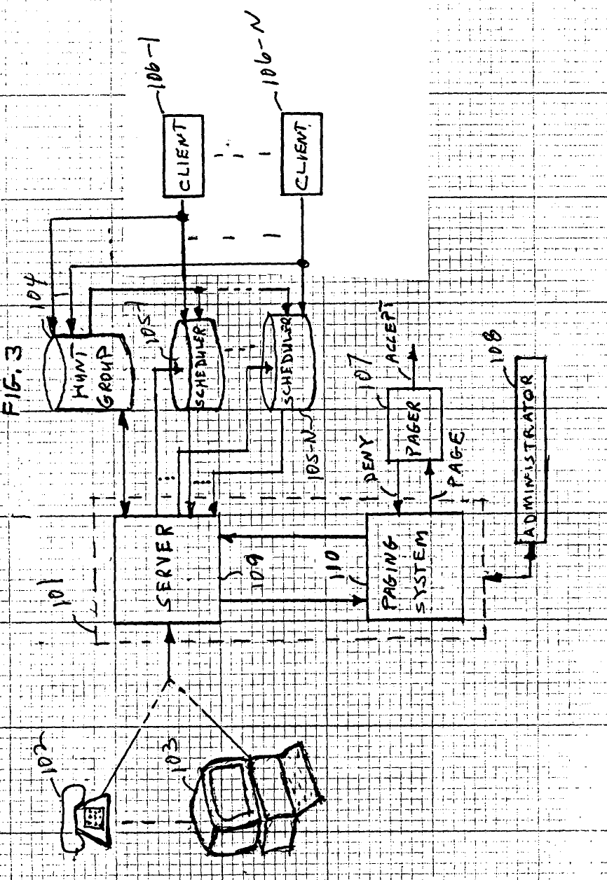

FIG. 3 shows, in simplified block diagram form, details of a paging system including still another embodiment of the invention. Elements of the system shown in FIG. 3 that are the same as those shown in FIG. 1 have been similarly numbered and those that have essentially similar functionality will not be discussed again in detail. As shown, the paging system of FIG. 3 includes paging system server 101, access units 102 and 103 among others, hunt group unit 104, a plurality of schedulers 105-1 through 105-N, a plurality of client units 106-1 through 106-N, pager unit 107 and administrator unit 108. The difference being the system of FIG. 3 and the system of FIG. 1 is that paging system server 101 is shown as including a separate server 109 and a separate paging system 110, otherwise the makeup of the paging system of FIG. 3 is identical of that of FIG. 1.

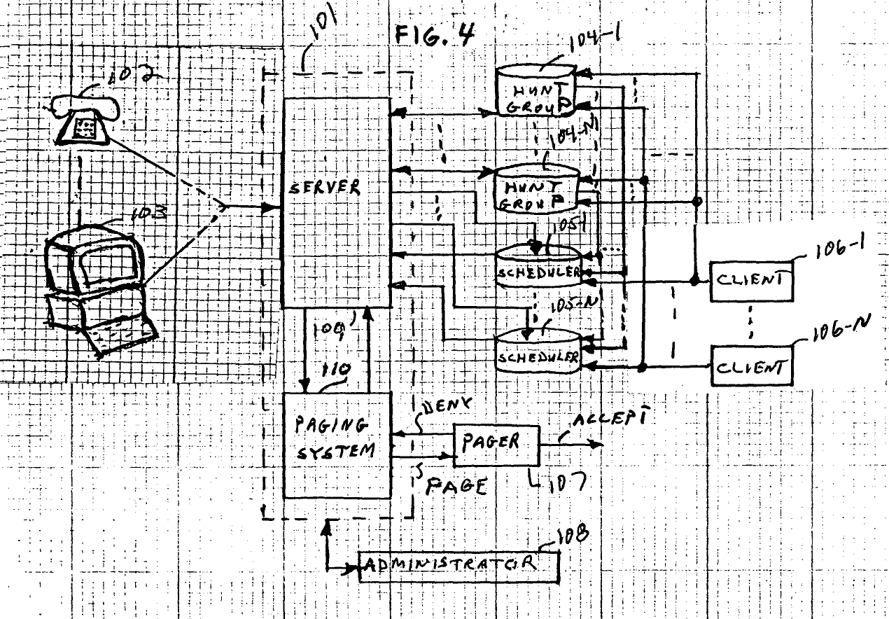

FIG. 4 shows, in simplified block diagram form, details of a paging system including a further embodiment of the invention. Elements of the system shown in FIG. 4 that are the same as those shown in FIGS. 1 and 2 have been similarly numbered and those that have essentially similar functionality will not be discussed again in detail. As shown, the paging system of FIG. 4 includes paging system server 101, access units 102 and 103 among others, a plurality of hunt group units 104-1 through 104-N, a plurality of schedulers 105-1 through 105-N, a plurality of client units 106-1 through 106-N, pager unit 107 and administrator unit 108. The difference being the system of FIG. 4 and the system of FIG. 2 is that paging system server 101 is shown as including a separate server 109 and a separate paging system 110, otherwise the makeup of the paging system of FIG. 4 is identical of that of FIG. 2. Each of the plurality of hunt groups 104-1 through 104-N may be populated with entities, for example, in relationship to a priority assigned to a source initiating the page or just to a specific source. Then, in this example, each of the hunt groups 104 has access to each of schedulers 105-1 through 105-N in order to hunt for an available entity in the group assigned to the source priority or just to the source.

FIG. 5 is a flow chart illustrating steps in one paging process that may be employed in the embodiments of FIGS. 1 and 3. Specifically, the process is started in step 501 by an indication that a page has been initiated. Then, step 502 causes a hunt group associated with the initiated page to be accessed. Step 503 causes hunt group unit 104 (FIGS. 1 or 3) to hunt for an entity to answer the page. As indicated above the entity may be anyone of possible such entities. For example, a CEO, company president, other executive, technical manager, engineer, product manager, marketer, salesperson, technician, some other service or organization or the like. In fact the entity can be anything or anyone that can address the purpose of the page, for example, it may be someone to just provide a warm fuzzy feeling to a customer or someone to provide information regarding an operational procedure, trouble analysis, or any other desired service or information. Indeed, the entity may be an individual, a company, another entity, a pointer to another hunt group, a pointer to a hierarchy of hunt groups or the like. A pointer to an particular entity is identified in step 504. Thereafter, the identified entity's scheduler 105 is accessed in step 505. Step 506 checks the identified entity's schedule. Then, step 507 tests to determine if the identified entity is available from the check of its schedule in step 506. If the test result in step 507 is NO, control is passed to step 508 and the hunt group hunts for the next entity in the group associated with the initiated page. Thereafter, steps 504 through 508 are iterated until step 507 yields a YES result indicating that the identified entity is available and control is passed to step 509. The entity identified as being available is paged via pager unit 107 in step 509. Then, step 510 tests to determine if the page has been denied by the identified entity. If the test result in step 510 is YES, control is passed to step 508 which causes the hunt group to search for the next entity in the associated group. Thereafter, steps 504 through 510 are iterated until step 510 yields a NO result, indicating that the page has been accepted by the identified, available entity. Then, the identified entity that accepted the page simply answers the page in step 511 and the process is ended.

FIG. 6 is a flow chart illustrating steps in another paging process that may be employed in the embodiments of FIGS. 1 and 3. Specifically, the process is started in step 601 by an indication that a page has been initiated. Then, step 602 causes a hunt group associated with the initiated page to be accessed. Step 603 causes hunt group unit 104 (FIGS. 1 or 3) to hunt for an entity to answer the page. As indicated above the entity may be anyone of possible such entities. For example, a CEO, company president, other executive, technical manager, engineer, product manager, marketer, salesperson, technician, some other service or organization or the like. In fact the entity can be anything or anyone that can address the purpose of the page, for example, it may someone to just provide a warm fuzzy feeling to a customer or someone to provide information regarding an operational procedure, trouble analysis, or any other desired service or information. Indeed, the entity may be an individual, a company, another entity, a pointer to another hunt group, a pointer to a hierarchy of hunt groups or the like. A particular entity is identified in step 604. Thereafter, the identified entity's scheduler 105 is accessed in step 605. Step 506 checks the identified entity's schedule. Then, step 607 tests to determine if the identified entity is available from the check of its schedule in step 606. If the test result in step 607 is NO, control is passed to step 608 and the hunt group hunts for the next entity in the group associated with the initiated page. Thereafter, steps 604 through 608 are iterated until step 607 yields a YES result indicating that the identified entity is available and control is passed to step 609. The entity identified as being available is paged via pager unit 107 in step 609. Then, step 610 tests to determine if the page has been denied by the identified entity. If the test result in step 610 is YES, control is passed to step 611 that tests to determine if the schedule of the entity that denied accepting the page should be updated. If the test in step 611 is YES, control is passed to step 612 which causes the denying entity's scheduler to be accessed and updated. As indicated above, administrator 108 may achieve this schedule updating. Thereafter, control is passed to step 608. Returning to step 611, if the test result is NO, control is also passed to step 608. Step 608 causes the hunt group to search for the next entity in the associated group. Thereafter, steps 604 through 611, and 612 if appropriate, are iterated until step 610 yields a NO result, indicating that the page has been accepted by the identified available entity. Then, the identified entity that accepted the page simply answers the page in step 613 and the process is ended.

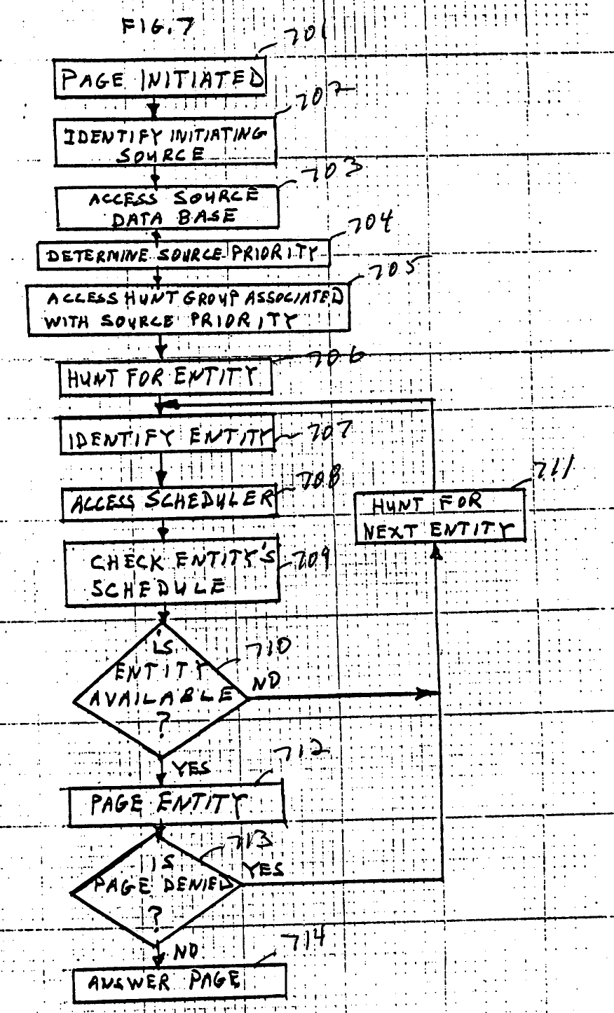

FIG. 7 is a flow chart illustrating steps in a paging process that may be employed in the embodiments of FIGS. 2 and 4. Specifically, the process is started in step 701 by an indication that a page has been initiated. Thereafter, step 702 identifies the source initiating the page. This can be realized in a number of known ways. One way being the use of a caller identification (ID) process. Step 703 causes a source database to be accessed that includes priority information. The database can be, for example, a lookup table. Then, step 704 determines the source priority level. Step 705 causes a hunt group to be accessed that is associated with the identified source priority level. Step 706 hunts for an entity to answer the page. As indicated above the entity may be anyone of possible such entities. For example, a CEO, company president, other executive, technical manager, engineer, product manager, marketer, salesperson, technician, some other service or organization or the like. In fact the entity can be anything or anyone that can address the purpose of the page, for example it may someone to just provide a warm fuzzy feeling to a customer or someone to provide information regarding an operational procedure, trouble analysis, or any other desired service or information. Indeed, the entity may be an individual, a company, another entity, a pointer to another hunt group, a pointer to a hierarchy of hunt groups or the like. A particular entity is identified in step 707. Thereafter, the identified entity's scheduler 105 is accessed in step 708. Step 709 checks the identified entity's schedule. Then, step 710 tests to determine if the identified entity is available from the check of its schedule in step 709. If the test result in step 710 is NO, control is passed to step 711 and the hunt group hunts for the next entity in the group associated with the initiated page. Thereafter, steps 707 through 711 are iterated until step 710 yields a YES result and control is passed to step 712. The entity identified as being available is paged via pager unit 107 in step 712. Then, step 713 tests to determine if the page has been denied by the identified entity. If the test result in step 713 is YES, control is passed to step 711 which causes the hunt group to search for the next entity in the associated group. Thereafter, steps 707 through 713 are iterated until step 713 yields a NO result, indicating that the page has been accepted by the identified entity. Then, the identified entity that accepted the page simply answers the page in step 714 and the process is ended.

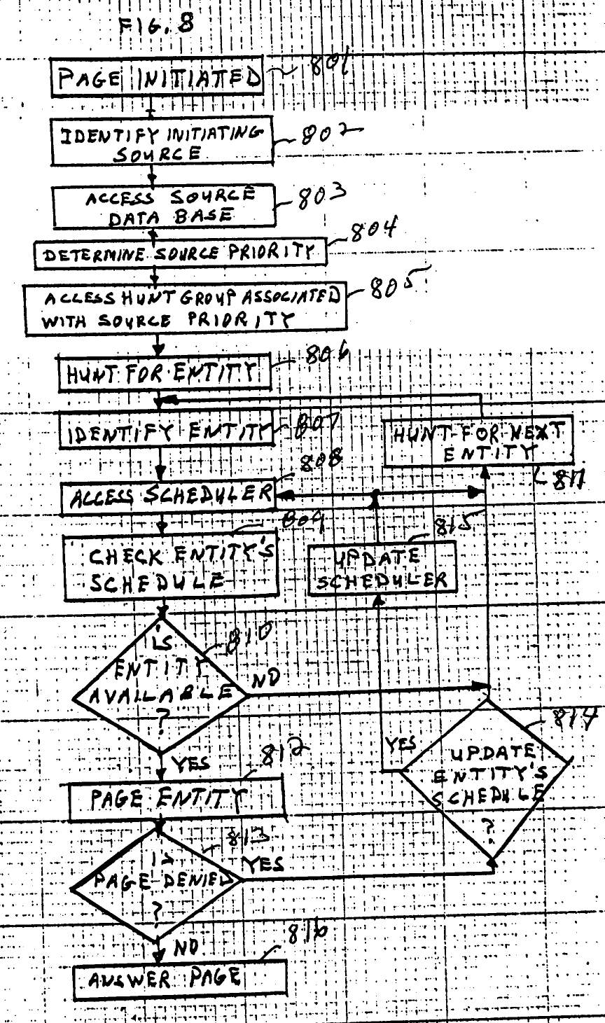

FIG. 8 is a flow chart illustrating steps in a paging process that may be employed in the embodiments of FIGS. 2 and 4. Specifically, the process is started in step 801 by an indication that a page has been initiated. Thereafter, step 802 identifies the source initiating the page. This can be realized in a number of known ways. One way being the use of caller identification (ID) process. Step 803 causes a source database to be accessed that includes priority information. The database can be, for example, a lookup table. Then, step 804 determines the source priority level. Step 805 causes a hunt group to be accessed that is associated with the identified source priority level. Step 806 hunts for an entity to answer the page. As indicated above the entity may be anyone of possible such entities. For example, a CEO, company president, other executive, technical manager, engineer, product manager, marketer, salesperson, technician, some other service or organization or the like. In fact the entity can be anything or anyone that can address the purpose of the page, for example it may someone to just provide a warm fuzzy feeling to a customer or someone to provide information regarding an operational procedure, trouble analysis, or any other desired service or information. Indeed, the entity may be an individual, a company, another entity, a pointer to another hunt group, a pointer to a hierarchy of hunt groups or the like. A particular entity is identified in step 807. Thereafter, the identified entity's scheduler is accessed in step 808. Step 809 checks the identified entity's schedule. Then, step 810 tests to determine if the identified entity is available from the check of its schedule in step 809. If the test result in step 810 is NO, control is passed to step 811 and the hunt group hunts for the next entity in the group associated with the initiated page. Thereafter, steps 807 through 811 are iterated until step 810 yields a YES result and control is passed to step 812. The entity identified as being available is paged in step 812. Then, step 813 tests to determine if the page has been denied by the identified entity. If the test result in step 813 is YES, control is passed to step 814 that tests to determine if the schedule of the entity that denied accepting the page should be updated. If the test in step 814 is YES, control is passed to step 815, which causes the denying entity's scheduler to be accessed and updated. Thereafter, control is passed to step 811. Returning to step 814, if the test result is NO, control is also passed to step 811. Step 811 causes the hunt group to search for the next entity in the associated group. Thereafter, steps 807 through 814, and 815 if appropriate, are iterated until step 813 yields a NO result, indicating that the page has been accepted by the identified entity. Then, the identified entity that accepted the page simply answers the page in step 816 and the process is ended.

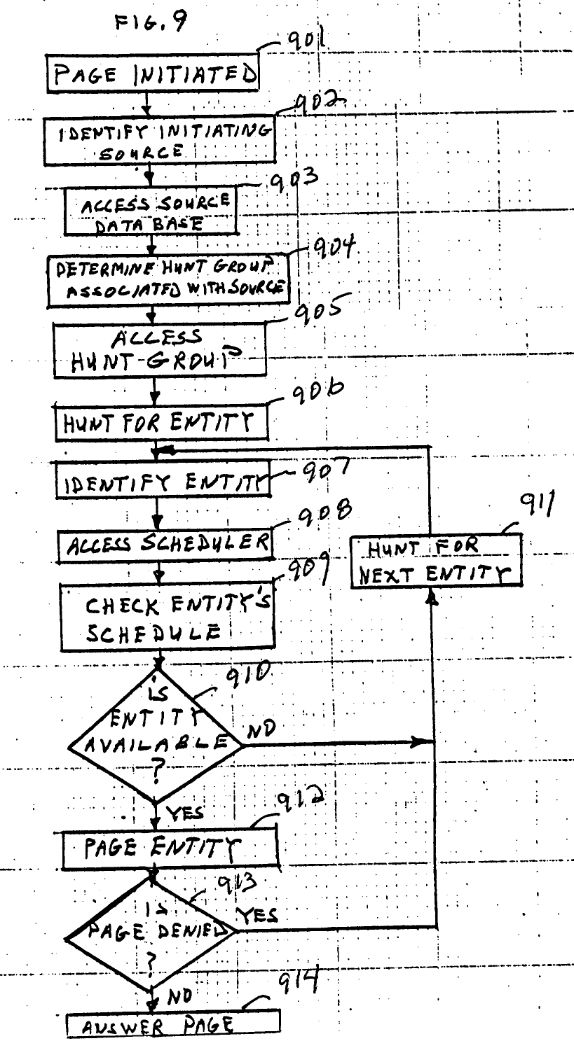

FIG. 9 is a flow chart illustrating steps in another paging process that may be employed in the embodiments of FIGS. 2 and 4. Specifically, the process is started in step 901 by an indication that a page has been initiated. Thereafter, step 902 identifies the source initiating the page. This can be realized in a number of known ways. One way being the use of a caller identification (ID) process. Step 903 causes a source database to be accessed that includes source information regarding a particular hunt group that is associated with it. The database can be, for example, a lookup table. Then, step 904 determines a hunt group associated with the source. The entities populating the group may be determined by any of a number of subject matters. Step 905 causes the hunt group to be accessed that is associated with the identified source. Step 906 hunts for an entity to answer the page. As indicated above, the entity may be anyone of possible such entities. For example, a CEO, company president, other executive, technical manager, engineer, product manager, marketer, salesperson, technician, some other service or organization or the like. In fact the entity can be anything or anyone that can address the purpose of the page, for example, it may someone to just provide a warm fuzzy feeling to a customer or someone to provide information regarding an operational procedure, trouble analysis, or any other desired service or information. Indeed, the entity may be an individual, a company, another entity, a pointer to another hunt group, a pointer to a hierarchy of hunt groups or the like. A particular entity is identified in step 907. Thereafter, the identified entity's scheduler is accessed in step 908. Step 909 checks the identified entity's schedule. Then, step 910 tests to determine if the identified entity is available from the check of its schedule in step 909. If the test result in step 910 is NO, control is passed to step 911 and the hunt group hunts for the next entity in the group associated with the initiated page. Thereafter, steps 907 through 911 are iterated until step 910 yields a YES result and control is passed to step 912. The entity identified as being available is paged in step 912. Then, step 913 tests to determine if the page has been denied by the identified entity. If the test result in step 913 is YES, control is passed to step 911 which causes the hunt group to search for the next entity in the associated group. Thereafter, steps 907 through 913 are iterated until step 913 yields a NO result, indicating that the page has been accepted by the identified entity. Then, the identified entity that accepted the page simply answers the page in step 914 and the process is ended.

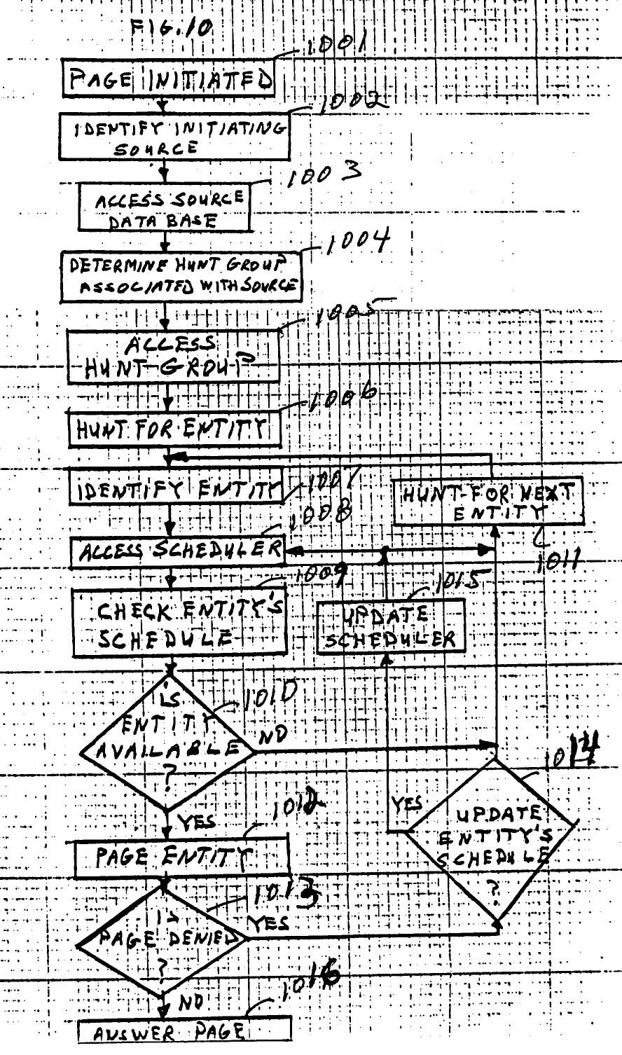

FIG. 10 is a flow chart illustrating steps in still another paging process that may be employed in the embodiments of FIGS. 2 and 4. Specifically, the process is started in step 1001 by an indication that a page has been initiated. Thereafter, step 1002 identifies the source initiating the page. This can be realized in a number of known ways. One way being the use of a caller identification (ID) process. Step 1003 causes a source database to be accessed that includes source information regarding a particular hunt group that is associated with it. The database can be, for example, a lookup table. Then, step 1004 determines the source priority level. Step 1005 causes a hunt group to be accessed that is associated with the identified source priority level. Step 1006 hunts for an entity to answer the page. As indicated above the entity may be anyone of possible such entities. For example, a CEO, company president, other executive, technical manager, engineer, product manager, marketer, salesperson, technician, some other service or organization or the like. In fact the entity can be anything or anyone that can address the purpose of the page, for example it may someone to just provide a warm fuzzy feeling to a customer or someone to provide information regarding an operational procedure, trouble analysis, or any other desired service or information. Indeed, the entity may be an individual, a company, another entity, a pointer to another hunt group, a pointer to a hierarchy of hunt groups or the like. A particular entity is identified in step 1007. Thereafter, the identified entity's scheduler is accessed in step 1008. Step 1009 checks the identified entity's schedule. Then, step 1010 tests to determine if the identified entity is available from the check of its schedule in step 1009. If the test result in step 1010 is NO, control is passed to step 1011 and the hunt group hunts for the next entity in the group associated with the initiated page. Thereafter, steps 1007 through 1011 are iterated until step 1010 yields a YES result and control is passed to step 1012. The entity identified as being available is paged in step 1012. Then, step 1013 tests to determine if the page has been denied by the identified entity. If the test result in step 1013 is YES, control is passed to step 1014 that tests to determine if the schedule of the entity that denied accepting the page should be updated. If the test in step 1014 is YES, control is passed to step 1015, which causes the denying entity's scheduler to be accessed and updated. Thereafter, control is passed to step 1011. Returning to step 1014, if the test result is NO, control is also passed to step 1011. Step 1011 causes the hunt group to search for the next entity in the associated group. Thereafter, steps 1007 through 1014, and 1015 if appropriate, are iterated until step 1013 yields a NO result, indicating that the page has been accepted by the identified entity. Then, the identified entity that accepted the page simply answers the page in step 1016 and the process is ended.

What is claimed is:

1. Apparatus for paging an entity comprising:
apparatus responsive to a page request for initiating selection of an entity to answer the page request;
a hunt group unit associated with said paging system server for storing a plurality of entities associated with a hunt group;
at least one scheduler unit for storing schedule data associated with the individual entities in said hunt group and indicating their individual availability to answer pages; and
wherein said apparatus for initiating the selection of an entity includes apparatus for causing said hunt group unit to select an individual entity from said hunt group, for accessing said at least one scheduler to determine if the selected entity is available to be paged and for paging an entity selected from said hunt group that has been determined to be available to answer said page request.

2. The invention as defined in claim 1 wherein said paging system server includes apparatus operative to cause said hunt group unit to select another entity when a currently selected entity is determined from said at least one scheduler unit to actually not be available to answer the page.

3. The invention as defined in claim 2 further including an administrator unit for updating the entity schedule data in said at least one scheduler unit.

4. The invention as defined in claim 3 wherein said administrator unit further is operative to update said entities in said hunt group.

5. The invention as defined in claim 2 further including a plurality of scheduler units associated on a one-to-one basis with individual ones of said plurality of entities in said hunt group.

6. The invention as defined in claim 5 further including a plurality of hunt group units each including a plurality of entities in a group.

7. The invention as defined in claim 6 each of said plurality of hunt group units has access to each of said plurality of scheduler units.

8. The invention as defined in claim 7 further including an administrator unit for updating the entity schedules in said plurality of scheduler units.

9. The invention as defined in claim 8 wherein said administrator unit further is operative to update said entities in said plurality of hunt groups.

10. The invention as defined in claim 7 further including apparatus for individual ones of said plurality of entities to update the hunt group or hunt groups that it is in.

11. The invention as defined in claim 7 further including apparatus for individual ones of said plurality of entities to update their schedules in an associated scheduler unit.

12. The invention as defined in claim 11 wherein one or more of said plurality of entities is an individual person.

13. The invention as defined in claim 11 wherein one or more of said entities is a pointer to at least one other hunt group.

14. The invention as defined in claim 6 wherein individual ones of said hunt groups are populated with entities based on a predetermined priority level assigned to the hunt group and further including apparatus for determining the identity of a page request source, apparatus for storing a priority level associated with said identified source and apparatus for assigning a hunt group having a priority level associated with the identified source to that source.

15. The invention as defined in claim 6 individual ones of said hunt groups are populated with entities based on a page requesting source and further including apparatus for determining the identity of a page request source, apparatus for storing data identifying the hunt group associated with said identified source and apparatus for assigning the hunt group associated with the identified source to that source.

16. Apparatus for paging an entity comprising:
means responsive to a page request for initiating the selection of an entity to answer the page request;
means for storing a plurality of entities associated with a hunt group;
at least one means for storing schedule data associated with the individual entities in said hunt group and for indicating their individual availability to answer pages;
means for causing said hunt group unit to select an individual entity from said hunt group;
means for accessing said at least one scheduler to determine if the selected entity is available to be paged; and
means for paging an available entity selected from said hunt group that has been determined to be available to answer said page request.

17. The invention as defined in claim 16 wherein said means for initiating a page includes means for causing said hunt group unit to select another entity when a currently selected entity is determined from said at least one scheduler unit to be not available to answer the page.

18. The invention as defined in claim 17 further including means for updating the entity schedules in said at least one means for storing schedule data.

19. The invention as defined in claim 18 wherein said means for updating further includes means for updating said entities in said hunt group.

20. The invention as defined in claim 17 further including a plurality of means for storing schedule data associated on a one-to-one basis with individual ones of said plurality of entities in said hunt group.

21. The invention as defined in claim 20 further including a plurality of means for storing a plurality of entities, each of said means for storing stores a plurality of entities associated with a particular hunt group.

22. The invention as defined in claim 21 wherein each of said plurality means for storing entities associated with a hunt group has access to each of said plurality of means for storing schedule data.

23. The invention as defined in claim 22 further including means for updating the entity schedules in said plurality of means for storing schedule data.

24. The invention as defined in claim 23 wherein said means for updating further includes means for updating said entities in said plurality of hunt groups.

25. The invention as defined in claim 22 further including means accessible to individual ones of said plurality of entities for updating the hunt group or hunt groups that said individual entity is in.

26. The invention as defined in claim 22 further including means accessible to individual ones of said plurality of entities for updating their schedules in an associated one of said means for storing schedule data.

27. The invention as defined in claim 26 wherein one or more of said plurality of entities is an individual person.

28. The invention as defined in claim 26 wherein one or more of said entities is a pointer to at least one other hunt group.

29. The invention as defined in claim 21 wherein individual ones of said hunt groups are populated with entities based on a predetermined priority level assigned to the hunt group and further including means for determining the identity of a page request source, means for storing a priority level associated with said identified source and means for assigning a hunt group having a priority level associated with the identified source to that source.

30. The invention as defined in claim 21 individual ones of said hunt groups are populated with entities based on a page requesting source and further including means for determining the identity of a page request source, means for storing data identifying the hunt group associated with said identified source and means for assigning the hunt group associated with the identified source to that source.

31. A method for paging an entity, comprising the steps of:
detecting reception of a request initiating a page;
storing a plurality of entities in a hunt group;
storing schedule data for said plurality of entities, said data indicating availability of individual ones of said entities to answer pages;
controllably selecting an entity from said hunt group to answer the page;
controllably accessing said stored schedule data to determine if the selected entity is indicated to be available to answer the page; and
if said selected entity is indicated to be available to answer the page, paging said selected entity.

32. The method as defined in claim 31 further including the step of selecting another entity from said hunt group when it is determined that a currently selected entity is actually not available to answer said page.

33. The method as defined in claim 32 further including the step of updating the stored schedule data of entities identified with a hunt group.

34. The method as defined in claim 32 further including a step of updating the stored entities associated with a hunt group.

35. The method as defined in claim 32 further including storing a plurality of units of schedule data, each of said plurality of units of schedule data being associated on a one-to-one basis with individual ones of said plurality of entities in said hunt group.

36. The method as defined in claim 35 further including a step of storing a plurality of hunt groups, each hunt group including a plurality of entities associated with it.

37. The method as defined in claim 36 including a step in which each of said plurality of hunt groups has access to each of said plurality of units of schedule data.

38. The method as defined in claim 37 further including a step of updating the entity schedules in said stored plurality of units of schedule data.

39. The method as defined in claim 38 further including a step of updating entities in each of said plurality of hunt groups.

40. The method as defined in claim 37 further including a step of an entity updating hunt groups it is in or is to be included in.

41. The invention as defined in claim 37 further including a step of updating each of said plurality of units of schedule data by an individual one of said plurality of entities associated with said unit of schedule data.

42. The invention as defined in claim 41 wherein one or more of said plurality of entities is an individual person.

43. The invention as defined in claim 41 wherein one or more of said entities is a pointer to at least one other hunt group.

44. The invention as defined in claim 36 wherein individual ones of said hunt groups are populated with entities based on a predetermined priority level assigned to the hunt group, and further including the steps of determining the identity of a page request source, storing a priority level associated with said identified source and assigning a hunt group having a priority level associated with the identified source to that source.

45. The invention as defined in claim 36 individual ones of said hunt groups are populated with entities based on a page requesting source and further including the steps of determining the identity of a page request source, storing data identifying the hunt group associated with said identified source and assigning the hunt group associated with the identified source to that source.
